(19) United States
(12) Patent Application Publication
(10) Pub. No.: US 2007/0104874 A1
(43) Pub. Date: May 10, 2007

(54) Metod for forming brilliant coating film and coated article showing metallic effect

(76) Inventors: Takeshi Ogawa, Saitama (JP); Satoru Ihara, Saitama (JP); Toshihiko Uchiyama, Osaka (JP); Masanobu Inoue, Osaka (JP); Seigo Miyazoe, Tokyo (JP); Ryuichi Shiraga, Tokyo (JP)

Correspondence Address: David B Ritchie;Thelen Reid & Priest, P O Box 640640, San Jose, CA, 95164-0640, US

(21) Appl. No.: 10/556,439

(22) PCT Filed: May 28, 2004
(86) PCT No.: PCT/JP04/07762

§ 371 Date: Nov. 10, 2005

(30) Foreign Application Priority Data
May 30, 2003 (JP) 2003-155609
May 30, 2003 (JP) 2003-155610
May 30, 2003 (JP) 2003-155611

(51) Int. Cl. B05D 3/02; B05D 1/36

(52) U.S. Cl. 427/372.2; 427/402

(57) ABSTRACT

There is provided a method for forming a brilliant coating film with an excellent brilliant appearance by using aqueous first and second base coating compositions without preheating the applied first base coating composition. In the method, the aqueous first base coating composition is applied to a substrate to form a first base coating, the aqueous second base coating composition is applied to the first base coating to form a second base coating, a clear coating composition is applied to the second base coating to form a clear coating, and then the uncured coatings formed are simultaneously heated and cured, under controlling the solid contents of the first and second base coating compositions and the ratio therebetween, or the brilliant pigment mass concentrations of the base coating compositions and the ratio therebetween, or the mass ratio, the evaporation rate, and the solubility parameter of a solvent contained in the first base coating composition.

### TECHNICAL FIELD

The present invention relates to a method for forming a brilliant coating film and an article coated with the brilliant coating film.

### RELATED ART

Brilliant coating compositions containing aluminum or mica flakes have been used for forming metallic coating films with metallic luster.

Methods for forming the brilliant coating films using the brilliant coating compositions include a method described in JP-A-2002-35688 of forming a metallic coating film excellent in orientation, density, flip-flop property, brilliantness, etc. In this multilayer film-forming method, a heat-curable base coating composition containing a hydrophilic organic solvent and water is applied to a substrate, the solid content of the surface of the applied composition is controlled to 70% by mass or more without curing the applied composition, a metallic coating composition containing a hydrophilic organic solvent is applied to the surface, and a clear coating composition is further applied if necessary.

However, the method of JP-A-2002-35688 requires measures against environmental affect of VOCs (volatile organic compounds) because the metallic coating composition containing a hydrophilic organic solvent as the second base coating composition contains only organic solvents without water. Further, the method comprises the step of preheating the applied heat-curable base coating composition to control the solid content to 70% by mass or more without curing the composition, whereby the method needs complicated lines with a preheating unit in a base coating zone.

Accordingly, an object of the present invention is to provide a method that can form a brilliant coating film with an excellent brilliant appearance by using aqueous first and second base coating compositions without preheating the applied first base coating composition, and a coated article having the brilliant coating film.

### SUMMARY OF THE INVENTION

As a result of intense research, the inventors have accomplished the present invention. More specifically, the following is provided.

1. A method for forming a brilliant coating film on a substrate, comprising in sequence the steps of:

(1) applying an aqueous first brilliant base coating composition to the substrate to form a first base coating at a first stage in a base coating zone;

(2) applying an aqueous second brilliant base coating composition to the first base coating obtained in the step (1) to form a second base coating at a second stage in the base coating zone;

(3) applying a clear coating composition to the second base coating obtained in the step (2) to form a clear coating in a clear coating zone; and

(4) simultaneously heating the uncured coatings formed in the steps (1), (2) and (3) to cure the coatings,

with at least one of the following provisos I, II, and III:

the proviso I of a condition (A-1) that the aqueous first brilliant base coating composition has a solid content of 10 to 45% by mass and the aqueous second brilliant base coating composition has a solid content of 10 to 40% by mass, and a condition (B-1) that the ratio of the solid content of the aqueous first brilliant base coating composition to the solid content of the aqueous second brilliant base coating composition is 1.1/1 to 4/1;

the proviso II of a condition (A-2) that the aqueous first brilliant base coating composition has a brilliant pigment mass concentration of 1 to 30% and the aqueous second brilliant base coating composition has a brilliant pigment mass concentration of 5 to 40%, and a condition (B-2) that the ratio of the brilliant pigment mass concentration of the aqueous first brilliant base coating composition to the brilliant pigment mass concentration of the aqueous second brilliant base coating composition is 1/4 to 1/1.1; and

the proviso IIII of a condition (A-3) that the aqueous first brilliant base coating composition comprises at least one organic solvent and water, and the mass ratio of the at least one organic solvent to the water is from 5/95 to 49/51, and a condition (B-3) that the at least one organic solvent used in the aqueous first brilliant base coating composition contains 40 to 100% by mass of a particular organic solvent, which has a solubility parameter of 9.5 to 14.5 and an evaporation rate of 150 to 800 when n-butyl acetate has an evaporation rate of 100 at 25° C.

2. A method for forming a brilliant coating film on a substrate, comprising in sequence the steps of

(1) applying an aqueous first brilliant base coating composition to the substrate to form a first base coating at a first stage in a base coating zone;

(2) applying an aqueous second brilliant base coating composition to the first base coating obtained in the step (1) to form a second base coating at a second stage in the base coating zone; and

(5) simultaneously heating the uncured coatings formed in the steps (1) and (2) to cure the coatings,

with at least one of the following provisos I, II, and III:

the proviso I of a condition (A-1) that the aqueous first brilliant base coating composition has a solid content of 10 to 45% by mass and the aqueous second brilliant base coating composition has a solid content of 10 to 40% by mass, and a condition (B-1) that the ratio of the solid content of the aqueous first brilliant base coating composition to the solid content of the aqueous second brilliant base coating composition is 1.1/1 to 4/1;

the proviso II of a condition (A-2) that the aqueous first brilliant base coating composition has a brilliant pigment mass concentration of 1 to 30% and the aqueous second brilliant base coating composition has a brilliant pigment mass concentration of 5 to 40%, and a condition (B-2) that the ratio of the brilliant pigment mass concentration of the aqueous first brilliant base coating composition to the brilliant pigment mass concentration of the aqueous second brilliant base coating composition is 1/4 to 1/1.1; and

the proviso III of a condition (A-3) that the aqueous first brilliant base coating composition comprises at least one organic solvent and water, and the mass ratio of the at least one organic solvent to the water is from 5/95 to 49/51, and a condition (B-3) that the at least one organic solvent used in the aqueous first brilliant base coating composition contains 40 to 100% by mass of a particular organic solvent, which has a solubility parameter of 9.5 to 14.5 and an evaporation rate of 150 to 800 when n-butyl acetate has an evaporation rate of 100 at 25° C.

3. The method for forming a brilliant coating film according to 1 or 2, wherein the method satisfies a condition (C) that the aqueous second brilliant base coating composition comprises at least one organic solvent and water, and the mass ratio of the at least one organic solvent to the water is from 5/95 to 49/51.

4. The method for forming a brilliant coating film according to any one from 1 to 3, wherein the method satisfies a condition (D) that the ratio of the dry film thickness of the first base coating to the dry film thickness of the second base coating is 1.5/1 to 5/1.

5. The method for forming a brilliant coating film according to any one from 1 to 4, wherein the aqueous second brilliant base coating composition contains 0.1 to 5 parts by mass of a fluorine- or silicone-based additive per 100 parts by mass of the vehicle solid contents.

6. A coated article comprising a brilliant coating film formed by the method according to any one from 1 to 5.

### BEST MODE FOR CARRYING OUT THE INVENTION

Constituents of the present invention are described in detail below.

First Method for Forming a Brilliant Coating Film

A first method according to an embodiment of the present invention for forming a brilliant coating film comprises in sequence the steps of (1) applying an aqueous first brilliant base coating composition to a substrate to form a first base coating at a first stage in a base coating zone; (2) applying an aqueous second brilliant base coating composition to the first base coating formed in the step (1) to form a second base coating at a second stage in the base coating zone; (3) applying a clear coating composition to the second base coating formed in the step (2) to form a clear coating in a clear coating zone; and (4) simultaneously heating the uncured coatings formed in the steps (1), (2) and (3) to cure the coatings, with at least one of the following provisos I, II, and III.

Proviso I

The proviso I is that the conditions (A-1) and (B-1) are satisfied. The condition (A-1) is that the aqueous first brilliant base coating composition has a solid content of 10 to 45% by mass and the aqueous second brilliant base coating composition has a solid content of 10 to 40% by mass. The condition (B-1) is that the ratio of the solid content of the aqueous first brilliant base coating composition to the solid content of the aqueous second brilliant base coating composition is from 1.1/1 to 4/1.

Proviso II

The proviso II is that the conditions (A-2) and (B-2) are satisfied. The condition (A-2) is that the aqueous first brilliant base coating composition has a brilliant pigment mass concentration (hereinafter referred to as “PWC”) of 1 to 30% and the aqueous second brilliant base coating composition has a brilliant pigment PWC of 5 to 40%. The condition (B-2) is that the ratio of the brilliant pigment PWC of the aqueous first brilliant base coating composition to the brilliant pigment PWC of the aqueous second brilliant base coating composition is 1/4 to 1/1.1.

Proviso III

The proviso III is that the conditions (A-3) and (B-3) are satisfied. The condition (A-3) is that the aqueous first brilliant base coating composition comprises a solvent containing at least one organic solvent and water, and the mass ratio of the at least one organic solvent to the water is from 5/95 to 49/51. The condition (B-3) is that the at least one organic solvent used in the aqueous first brilliant base coating composition contains 40 to 100% by mass of a particular organic solvent, which has a solubility parameter of 9.5 to 14.5 and an evaporation rate of 150 to 800 when n-butyl acetate has an evaporation rate of 100 at 25° C.

Second Method for Forming Brilliant Coating Film

A second method according to an embodiment of the present invention for forming a brilliant coating film comprises in sequence the steps of (1) applying an aqueous first brilliant base coating composition to a substrate to form a first base coating at a first stage in a base coating zone; (2) applying an aqueous second brilliant base coating composition to the first base coating formed in the step (1) to form a second base coating at a second stage in the base coating zone; and (5) simultaneously heating the uncured coatings formed in the steps (1) and (2) to cure the coatings, with at least one of the above provisos I, II, and III.

Third Method for Forming Brilliant Coating Film

A third method according to an embodiment of the present invention for forming a brilliant coating film is the first or second method with the condition (C) that the aqueous second brilliant base coating composition comprises a solvent containing at least one organic solvent and water, and the mass ratio of the at least one organic solvent to the water is from 5/95 to 49/51.

Fourth Method for Forming Brilliant Coating Film

A fourth method according to an embodiment of the present invention for forming a brilliant coating film is any one of the first to third methods with the condition (D) that the ratio of the dry film thickness of the first base coating to the dry film thickness of the second base coating is from 1.5/1 to 5/1.

Fifth Method for Forming Brilliant Coating Film

A fifth method according to an embodiment of the present invention for forming a brilliant coating film is any one of the first to fourth methods, in which the aqueous second brilliant base coating composition contains 0.1 to 5 parts by mass of a fluorine- or silicone-based additive per 100 parts by mass of the vehicle solid content.

Substrate

Materials for the substrate used in the methods according to an embodiment of the present invention for forming a brilliant coating film are not limited, but include metals such as iron, aluminum, copper, and alloys thereof; inorganic materials such as glass, cement, and concrete; plastic materials such as resin (e.g. polyethylene resin, polypropylene resin, ethylene-vinyl acetate copolymer resin, polyamide resin, acrylic resin, vinylidene chloride resin, polycarbonate resin, polyurethane resin, epoxy resin, etc.) and FRP (fiber-reinforced plastic); and natural or synthetic materials such as wood material and textile material (e.g. paper, cloths, etc.).

In the methods according to the embodiments of the present invention for forming a brilliant coating film, if a conductive substrate for a main body or parts of the automobile is employed, the substrate may be coated with an undercoating film (by a chemical treatment, an electrodeposition coating, etc.)or with an intermediate coating film in addition to such an undercoating film. If a non-conductive substrate for a main body or parts of the automobile is employed, the substrate may be coated with a primer after a chemical treatment and if necessary a conductive treatment.

The undercoating film acts to improve the adhesion of the brilliant coating film to the substrate, the property of hiding or covering or concealing the substrate, the anticorrosion property, and the rust preventive property. The undercoating film may be formed by applying, baking, and curing an undercoating composition. The undercoating film may have a dry film thickness of 8 to 30 μm. The undercoating composition is not particularly limited, but may include various kinds of compositions such as a cationic electrodeposition coating composition and an anionic electrodeposition coating composition. The electrodeposition coating composition is electrodeposited and cured by baking in a condition in accordance with the type of the composition.

The intermediate coating film may be formed on the substrate or on the undercoating film by applying an intermediate coating composition to improve the adhesion of the brilliant coating film to the substrate or the undercoating film, the property of hiding or covering or concealing the substrate or the undercoating film, and the chipping resistance. The intermediate coating film may have a dry film thickness of 10 to 50 μm. For example, the intermediate coating composition may be a composition containing a hydroxyl-containing polyester resin and/or a hydroxyl-containing acrylic resin, and a melamine resin and/or a blocked polyisocyanate. Such a composition is applied, and dried or cured at a room temperature or a baking temperature in accordance with the type of the composition.

In the methods for forming a brilliant coating film according to an embodiment of the present invention, the base coating zone is an area in which the base coatings are formed, and the base coatings are lower layers of the multilayered overcoating film.

In the methods for forming a brilliant coating film according to an embodiment of the present invention, the clear coating zone is an area in which the clear coating (or the clear top coating) is formed, and the clear top coating is an upper layer of the multilayered overcoating film.

In the methods for forming a brilliant coating film according to an embodiment of the present invention, the base coatings are successively formed in the base coating zone. The first base coating is formed at the first stage and the second base coating is formed at the second stage. In the embodiment of the present invention, it is important that different particular coating compositions are used respectively at the first and second stages.

Step (1)

In the step (1) of the methods for forming a brilliant coating film according to an embodiment of the present invention, the first base coating is formed by applying the aqueous first brilliant base coating composition (which may be referred to as the aqueous first base coating composition) at the first stage in the base coating zone.

The aqueous first base coating composition contains an aqueous resin as a vehicle-forming resin. The aqueous resin can be made hydrophilic by controlling the acid value and by neutralizing the carboxyl groups (for example, 50% or more of the carboxyl groups) of the resin with a basic substance. In the embodiment of the present invention, the aqueous resin may include a water-soluble resin, a water-dispersible resin, and an emulsion resin. Examples of the basic substances include ammonia, methylamine, ethylamine, dimethylamine, diethylamine, trimethylamine, triethylamine, dimethylethanolamine, diethanolamine, triethanolamine, etc. More preferable among them are diethanolamine, dimethylethanolamine, and triethanolamine. The solvent for the aqueous first base coating composition may be composed mainly of water and may contain organic solvents.

For the vehicle-forming resin, an acrylic resin or a polyester resin may be used along with an amino resin and/or a blocked polyisocyanate and/or polycarbodilmide compound as a crosslinking agent for the resin. The acrylic resin is more preferably used for forming the base coating.

The acrylic resin may be a copolymer of acrylic monomers and other ethylenic unsaturated monomers. Examples of the acrylic monomers usable for the copolymer include acrylic or methacrylic ester such as methyl, ethyl, propyl, n-butyl, i-butyl, t-butyl, 2-ethylhexyl, lauryl, phenyl, benzyl, 2-hydroxyethyl, or 2-hydroxypropyl ester; amide group-containing acryl monomers such as acrylamide, methacrylamide, N,N-dimethylacrylamide, N,N-dimethylmethacrylamide, N,N-dibutylacrylamide, and N,N-dibutylmethacrylamide; caprolactone ring-opened adducts of 2-hydroxyethyl acrylate or methacrylate; (meth)acrylic esters of polyhydric alcohols; etc. Examples of the other ethylenic unsaturated monomers that can be copolymerized with the acrylic monomers include styrene, α-methylstyrene, itaconic acid, maleic acid, vinyl acetate, etc.

Examples of the polyester resins include oil-free polyester resins obtained by condensation of a polyhydric alcohol and a polybasic acid, and oil-modified polyester resins obtained by reacting a polyhydric alcohol and a polybasic acid with an oil component of one or more fatty acids of a castor oil, a dehydrated castor oil, a tung oil, a safflower oil, a soybean oil, a linseed oil, a tall oil, a coconut oil, etc.

As the crosslinking agent, an amino resin and/or a blocked polyisocyanate or polycarbodiimide compound may be used, and an amino resin may be more preferably used. Specific examples of the crosslinking agents include di-, tri-, tetra-, penta-, or hexa-methylolmelamines and alkyl ethers thereof, in which the alkyl group is methyl, ethyl, propyl, isopropyl, butyl, isobutyl, etc.; urea-formaldehyde condensation products; urea-melamine co-condensation products; etc. Melamine resins are more preferably used as the crosslinking agent.

The blocked polyisocyanate compound is a polyisocyanate compound blocked by a blocking agent. The blocking moiety in the blocked polyisocyanate compound is dissociated under a heating condition. Examples of the polyisocyanate compounds include aliphatic diisocyanates such as trimethylene diisocyanate, hexamethylene diisocyanate, and propylene diisocyanate; aromatic diisocyanates such as phenylene diisocyanate and naphthalene diisocyanate; aliphatic-aromatic isocyanates such as toluene diisocyanate and tolylene dilsocyanate; tri- or more polyisocyanates such as triphenylmethane triisocyanate; dimers and trimers of tolylene diisocyanate; etc. Examples of the blocking agents include alcohols such as methyl alcohol and ethyl alcohol; tertiary amines such as diethanolamine; lactams such as caprolactam; oximes such as methyl ethyl ketoxime; etc.

The polycarbodiimide compound has at least two carbodiimide groups (—N═C═N— groups). Specific examples of the polycarbodiimide compounds include poly(4,4′-diphenylmethane carbodiimide), poly(3,3′-dimethyl-4,4′-biphenylmethane carbodiimide), poly(tolylcarbodiimide), poly(p-phenylene carbodiimide), poly(m-phenylene carbodiimide), poly(3,3′-dimethyl,4′-diphenylmethane carbodiimide), poly(naphthylene carbodiimide), poly(1,6-hexamethylene carbodiimide), poly(4,4′-methylene biscyclohexylcarbodiimide), poly(1,4-tetramethylene carbodiimide), poly(1,3-cyclohexylene carbodiimide), poly(1,4-cyclohexylene carbodiimide), poly(1,3-diisopropylphenylene carbodiimide), poly(1-methyl-3,5-diisopropylphenylene carbodiimide), poly(1,3,5-triethylphenylene carbodiimide), poly(triisopropylphenylene carbodiimide), etc.

In the vehicle of the aqueous first base coating composition, the mass ratio between the vehicle-forming resin and the crosslinking agent is such that the vehicle-forming resin content is 50 to 90% by mass and the crosslinking agent content is 10 to 50% by mass, more preferably such that the vehicle-forming resin content is 60 to 85% by mass and the crosslinking agent content is 15 to 40% by mass. When the crosslinking agent content is less than 10% by mass (or when the vehicle-forming resin content is more than 90% by mass), the crosslinking may be insufficient. On the other hand, when the crosslinking agent content is more than 50% by mass (or when the vehicle-forming resin content is less than 50% by mass), the storage stability of the coating composition is reduced and the curing rate is increased, thereby resulting in poor appearance of the coating.

The aqueous first base coating composition contains a brilliant pigment, and may further contain a color pigment and an extender pigment if necessary. The brilliant pigment preferably may include at least one brilliant pigment selected from the group consisting of an aluminum flake pigment, a metal oxide-coated alumina flake pigment, a metal oxide-coated silica flake pigment, a graphite pigment, an interference mica pigment, a color mica pigment, a metallic titanium flake pigment, a stainless steel flake pigment, an iron oxide plate pigment, a metal-plated glass flake pigment, a metal oxide-coated plated glass flake pigment, a hologram pigment, and a flake pigment composed of cholesteric liquid crystal polymers. The brilliant pigment may preferably comprises an aluminum flake pigment, a metal oxide-coated alumina flake pigment, a metal oxide-coated silica flake pigment, a graphite pigment, an interference mica pigment, a color mica pigment, a metallic titanium flake pigment, a stainless steel flake pigment, an iron oxide plate pigment, a metal-plated glass flake pigment, a metal oxide-coated plated glass flake pigment, a hologram pigment, a flake pigment composed of cholesteric liquid crystal polymers, or a combination thereof.

Examples of the color pigments include organic pigments such as an azo lake pigment, an insoluble azo pigment, a condensed azo pigment, a phthalocyanine pigment, an indigo pigment, a perynone pigment, a perylene pigment, a phthalone pigment, a dioxazine pigment, a quinacridon pigment, an iso-indolinone pigment, a benzimidazolone pigment, a diketopyrrolopyrrole pigment, and a metal complex pigment; and inorganic pigments such as iron oxide yellow, iron oxide red, carbon black, and titanium dioxide. Examples of the extender pigments include talc, calcium carbonate, precipitated barium sulfate, silica, etc.

The aqueous first base coating composition is generally provided in such a way that the above components are dissolved or dispersed in water (or deionized water) as a solvent (or dispersant). A composition comprising hydrophilic organic solvents substituting the water may also be included. In a mixture system of both water and organic solvents, the water content of the whole solvent may be from 51 to 100% by mass and the organic solvent content may be from 0 to 49% by mass, such that the water content may be higher than the organic solvent content.

The organic solvent may comprise such a solvent that is commonly used for the coating composition. Examples of the organic solvent may include hydrocarbons such as toluene and xylene; ketones such as acetone and methyl ethyl ketone; esters such as ethyl acetate, butyl acetate, cellosolve acetate, and butyl cellosolve; and alcohols. More preferred organic solvents include hydrophilic alcohol solvents.

Examples of the hydrophilic alcohol solvents may include methyl alcohol, ethyl alcohol, n-propyl alcohol, isopropyl alcohol, sec-butyl alcohol, tert-butyl alcohol, ethylene glycol, 1,2-propylene glycol, 1,3-butylene glycol, 2,3-butylene glycol, hexylene glycol, 2,5-hexanediol, dipropylene glycol, etc.

Condition (A-3): Organic Solvent/Water Ratio of Solvent in Aqueous First Base Coating Composition

According to an embodiment of the present invention, in the method for forming a brilliant coating film with the proviso IIII, the solvent contained in the aqueous first base coating composition has the mass ratio of the organic solvent to the water (being referred to as “organic solvent/water ratio”) from 5/95 to 49/51. When the organic solvent/water ratio is less than 5/95, the degree of dispersion of the components of the coating composition, particularly the brilliant pigment, may be reduced, thereby failing to achieve the splendid appearance. When the organic solvent/water ratio is more than 49/51, the VOC (volatile organic compound) content may be increased.

Condition (B-3): Particular Organic Solvent for Aqueous First Base Coating Composition

According to an embodiment of the present invention, in the method for forming a brilliant coating film with the proviso IIII, the above organic solvent used for the solvent of the aqueous first brilliant base coating composition contains 40 to 100% by mass of a particular organic solvent. The particular organic solvent has an evaporation rate of 150 to 800 when n-butyl acetate has an evaporation rate of 100 at 25° C. Further, the particular organic solvent has a solubility parameter of 9.5 to 14.5.

When the evaporation rate of the particular organic solvent for the aqueous first base coating composition is less than 150, the particular organic solvent evaporates from the coating at a very low rate so that the dripping property and the appearance may be deteriorated. When the evaporation rate of the particular organic solvent is more than 800, the storage stability of the coating composition may be lowered due to the large volatilization volume, The evaporation rate may be more preferably from 200 to 750.

When the solubility parameter of the particular organic solvent for the aqueous first base coating composition is less than 9.5, the particular organic solvent may be separated from the coating composition. When the solubility parameter is more than 14.5, the particular organic solvent is volatilized from the coating at a low rate. The solubility parameter is more preferably from 9.7 to 14.5.

The organic solvent(s) containing less than 40% by mass of the particular organic solvent is disadvantageous in that the orientation of the brilliant materials is worsened, etc. The organic solvent(s) preferably contains 50 to 100% by mass of the particular organic solvent.

The evaporation rate of the particular organic solvent is a relative value measured by a gravimetric method under the assumption that the evaporation rate of n-butyl acetate is 100 at 25° C., which is a value described in Paul Nylen, et al, Modern Sufface Coatings, 1965. The solubility parameter of the particular organic solvent is determined based on values described in C. M. Hansen, Ind. Eng. Chem. Prod. Res. Develop., 8[1]2 (1969).

The evaporation rates and the solubility parameters of typical organic solvents commonly used in the field of coating compositions are described below. The typical organic solvents include hydrocarbons such as toluene (evaporation rate 195, solubility parameter 8.9) and xylene (evaporation rate 68, solubility parameter 8.8); ketones such as acetone (evaporation rate 720, solubility parameter 9.8) and methyl ethyl ketone (evaporation rate 465, solubility parameter 9.3); esters such as ethyl acetate (evaporation rate 525, solubility parameter 9.1) and butyl acetate (evaporation rate 100, solubility parameter 8.5); and alcohols such as methyl alcohol (evaporation rate 370, solubility parameter 14.5), ethyl alcohol (evaporation rate 203, solubility parameter 13.0), isopropyl alcohol (evaporation rate 205, solubility parameter 11.5), n-butyl alcohol (evaporation rate 49, solubility parameter 11.3), propylene glycol (evaporation rate 1, solubility parameter 14.8), and 2-butoxyethanol (evaporation rate 10, solubility parameter 10.2).

The aqueous first base coating composition may contain an additive in addition to the above components, and examples of the additives include anti-precipitation agents, curing catalysts, ultraviolet absorbers, antioxidants, leveling agents, surface controlling agents such as silicones and organic polymers, anti-dripping agents, thickeners, defoaming agents, lubricants, and cross-linked polymer particles (or microgels).

Step (2)

According to an embodiment of the present invention, in the step (2) of the method for forming a brilliant coating film, the second base coating is formed by applying the aqueous second brilliant base coating composition (which may be referred to as the aqueous second base coating composition) onto the first base coating formed in the step (1) at the second stage in the base coating zone.

The aqueous second base coating composition used in the second stage of the base coating zone may comprise the vehicle, the pigment, the solvent, and the additive usable for the aqueous first base coating composition.

Condition (C): Organic Solvent/Water Ratio of Solvent in Aqueous Second Base Coating Composition

According to an embodiment of the present invention, in the third method for forming a brilliant coating film, the brilliant coating film is formed under the condition (C) that the solvent contained in the aqueous second base coating composition has the organic solvent/water ratio of 5/95 to 49/51. Thus, the solvent of the aqueous second base coating composition has more water than the organic solvent. When the organic solvent/water mass ratio is less than 5/95, the degree of dispersion of the brilliant components of the coating composition may be lowered, thereby failing to achieve the splendid appearance. When the organic solvent/water mass ratio is more than 49/51, the composition is not so preferable in the viewpoint of the VOC. The organic solvent/water mass ratio may be more preferably from 10/90 to 45/55.

Amount of fluorine- or silicone-based additive used in aqueous second base coating composition

According to an embodiment of the present invention, in the fifth method for forming a brilliant coating film, the aqueous second base coating composition contains 0.1 to 5 parts by mass of the fluorine- or silicone-based additive per 100 parts by mass of the vehicle solid contents, whereby the surface tension of the composition is reduced to improve the property of wetting with the aqueous first base coating.

Examples of the fluorine-based additives may include fluorinated alkyl carboxylates, fluorinated alkyl alkoxylates, and fluorinated alkyl esters.

Examples of the silicone-based additives may include polyether-modified polymethylalkylsiloxanes, polyether-modified polydimethylsiloxanes, polyester-modified polymethylalkylsiloxanes, silicone-modified polyacryls, and aralkyl-modified polymethylalkylsiloxanes.

When the amount of the fluorine- or silicone-based additive is less than 0.1 parts by mass per 100 parts by mass of the vehicle solid content, the surface tension may not be sufficiently reduced. When the amount is more than 5 parts by mass, the coating film performances may be deteriorated. The amount of the fluorine- or silicone-based additive is more preferably 0.2 to 2 parts by mass.

Condition (A-1): Solid Contents of Aqueous First and Second Base Coating Compositions

According to an embodiment of the present invention, in the method for forming a brilliant coating film with the proviso 1, the aqueous first base coating composition has the solid content of 10 to 45% by mass, and the aqueous second base coating composition has the solid content of 10 to 40% by mass. When the solid content of the aqueous first base coating composition is less than 10% by mass, a larger amount of the composition is used to form the coating with a desired thickness, resulting in poor coating efficiency. When the solid content of the aqueous first base coating composition is more than 45% by mass, the appearance of the coating is deteriorated. The aqueous first base coating composition preferably has a solid content of 15 to 40% by mass. When the solid content of the aqueous second base coating composition is less than 10% by mass, a larger amount of the composition is used to form the coating with a desired thickness, resulting in poor coating efficiency. When the solid content of the aqueous second base coating composition is more than 40% by mass, the orientation of the brilliant pigments is deteriorated. The aqueous second base coating composition preferably has a solid content of 11 to 30% by mass. Each coating composition has the above solid content at the time the composition is applied, and the solid content is equal to a heating residue content obtained by heating the composition to remove the volatile components. In the present invention, the heating residue content is obtained from the difference between mass values of the coating composition measured before and after heating the composition at 105° C. for 3 hours.

Condition (B-1): Solid Content Ratio between Aqueous First and Second Base Coating Compositions

According to an embodiment of the present invention, in the method for forming a brilliant coating film with the proviso 1, the solid content ratio of the solid content of the aqueous first base coating composition to that of the aqueous second base coating composition is from 1.1/1 to 4/1. Thus, the solid content of the aqueous first base coating composition is more than that of the aqueous second base coating composition. When the solid content ratio is not within the above range, the orientation of the brilliant pigments may be deteriorated. More preferably, the solid content ratio may be from 1:3/1 to 2.5/1.

Condition (D): Dry Film Thickness Ratio between Aqueous First and Second Base Coatings

According to an embodiment of the present invention, the fourth method for forming a brilliant coating film, the dry film thickness ratio of the dry film thickness of the first base coating to that of the second base coating is from 1.5/1 to 5/1. Thus, the dry film thickness of the aqueous first base coating is larger than that of the aqueous second base coating. When the dry film thickness ratio between the first and second base coatings is less than 1.5/1, the orientation of the brilliant pigments may be deteriorated. If the dry film thickness ratio is more than 5/1, the brilliantness may become uneven. The dry film thickness ratio may be more preferably from 1.5/1 to 3/1.

The aqueous first base coating preferably has a dry film thickness of 5 to 15 μm, and the aqueous second base coating preferably has a dry film thickness of 2 to 8 μm.

Condition (A-2): Brilliant Pigment PWCs of Aqueous First and Second Base Coating Compositions

According to an embodiment of the present invention, in the method for forming a brilliant coating film with the proviso II, the aqueous first base coating composition has the brilliant pigment PWC of I to 30%, and the aqueous second base coating composition has the brilliant pigment PWC of 5 to 40%. When the brilliant pigment PWC of the aqueous first base coating composition is less than 1%, the hiding property may be insufficient. When the brilliant pigment PWC of the aqueous first base coating composition is more than 30%, the coating performance may be deteriorated. The aqueous first base coating composition more preferably may have a brilliant pigment PWC of 3 to 25%. When the brilliant pigment PWC of the aqueous second base coating composition is less than 5%, the brilliantness may be insufficient. When the brilliant pigment PWC of the aqueous second base coating composition is more than 40%, the orientation of the brilliant pigments may be deteriorated to lower the coating appearance. The aqueous second base coating composition more preferably may have a brilliant pigment PWC of 7 to 30%. The brilliant pigments preferably have a flip-flop property, which means that the reflection light intensity is changed depending on the observation angle (or the light-receiving angle).

Condition (B-2): Brilliant Pigment PWC Ratio between Aqueous First and Second Base Coating Compositions

According to an embodiment of the present invention, in the method for forming a brilliant coating film with the proviso II, the brilliant pigment PWC ratio of the brilliant pigment PWC of the aqueous first base coating composition to that of the aqueous second base coating composition is from 1/4 to 1/1.1. Thus, the brilliant pigment PWC of the aqueous second base coating composition is larger than that of the aqueous first base coating composition. If the brilliant pigment PWC ratio is less than 114, the brilliantness may become uneven. On the other hand, when the brilliant pigment PWC ratio is more than 1/1.1, the orientation of the brilliant pigments may be insufficient. More preferably, the brilliant pigment PWC ratio may be from 1/1.5 to 1/3.5.

The aqueous first and second base coatings are preferably formed by a spray coating process. Specifically, the formed aqueous first base coating may be subjected to setting and then coated wet-on-wet with the aqueous second base coating. The formed aqueous second base coating may be subjected to setting for 2 minutes, and then preheated at 40 to 80° C. for 1 to 10 minutes with a drying furnace if necessary, to obtain uncured base coatings.

A rotary atomizing-type bell-shaped coating apparatus or an air atomizing-type coating apparatus is preferably used as a spray gun in the spray coating process. For example, Metallic bell G1-COPES bell (ABB Industry Corp.) may be used as the rotary atomizing-type bell-shaped coating apparatus. When the rotary atomizing-type coating apparatus is used, the rotating speed may be preferably 2×10⁴ to 4×10⁴ rpm, and the discharge rate may be preferably 80 to 250 cc/min.

Step (3)

According to an embodiment of the present invention, in the step (3) of the method for forming a brilliant coating film, the clear coating is formed by applying the clear coating composition onto the aqueous second base coating formed in the step (2) in the clear coating zone.

According to an embodiment of the present invention, it should be noted that the second method for forming a brilliant coating film comprises the steps (1), (2), and (5) such that the steps (3) and (4) are omitted.

In the step (3), the clear coating is formed on the uncured second base coating film obtained in the step (2) in the clear coating zone. The clear coating film may be a transparent colorless coating film that does not hide the base coating film, or a translucent, so-called colored clear coating film. Such a clear coating film as the top clear coating film is formed on the base coating films that the brilliantness may be improved and that projecting pigments from the base coating films may be covered with the clear coating film.

A coating composition that is usually used for overcoating may be used as the clear coating composition for the clear coating film. For example, a mixture of the above-mentioned crosslinking agent and at least one heat-curable resin selected from acrylic resins, polyester resins, fluororesins, epoxy resins, polyurethane resins, polyether resins, and modified resins thereof may be used as the clear coating composition. Further, at least one heat-curable resin, which may be mixed with the above-mentioned crosslinking agent, may be selected from the group consisting of acrylic resins, polyester resins, fluororesins, epoxy resins, polyurethane resins, polyether resins, and modified resins thereof such that a mixture of the selected resin and the agent may be used as the clear coating composition.

The clear coating composition can contain an additive such as a color pigment, an extender pigment, a modifying agent, an ultraviolet absorber, a leveling agent, a dispersing agent, and a defoaming agent, as long as the additive does not impair the transparency of the composition. A composition described in JP-B-8-19315, which contains a carboxyl-containing polymer and an epoxy-containing polymer, may be preferably used as the clear coating composition from the viewpoint of acid rain resistance. The clear coating composition may be an organic solvent type, an aqueous type, powder type, etc. The organic solvent or aqueous type clear coating composition may be a one-pack type composition or a two-pack type composition such as a two-pack urethane resin coating composition.

The clear coating film preferably may have a dry film thickness of 10 to 60 μm. When the dry film thickness is not within the range, there may be defects in the clear coating film appearance and disadvantages in the coating workability. The dry film thickness may be more preferably from 20 to 50 μm.

Step (4)

According to an embodiment of the present invention, in the step (4) of the first method for forming a brilliant coating film, the uncured coating film formed in the steps (1), (2) and (3) are simultaneously heated and cured.

The uncured coating film formed in the steps (1), (2) and (3) are dried or cured at a predetermined temperature for a predetermined period of time in a drying zone adjacent to the clear coating zone, to form the multilayered brilliant coating film on the substrate. The temperature and the period of time for drying or curing may be determined in accordance with the types of the aqueous first base coating composition, the aqueous second base coating composition, and the clear coating composition.

Step (5)

According to an embodiment of the present invention, in the step (5) of the second method for forming a brilliant coating film, the uncured coating film formed in the steps (1) and (2) are simultaneously heated and cured.

The uncured coating film formed in the steps (1) and (2) are dried or cured at a predetermined temperature for a predetermined period of time in an appropriately disposed drying zone, to form the multilayered brilliant coating film on the substrate. The temperature and the period of time for drying or curing may be determined in accordance with the types of the aqueous first and second base coating compositions.

Coated Article

According to an embodiment of the present invention, the coated article comprises the brilliant coating film formed by any one of the first to fifth methods as described above. In the case of using the first method, the coated article comprises the brilliant coating film formed on the substrate in the steps (1) to (4) with at least one of the provisos I, II, and III. In the case of using the second method, the coated article comprises the brilliant coating film formed on the substrate in the steps (1), (2), and (5) with at least one of the provisos I, II, and III. In the case of using the third method, the coated article comprises the brilliant coating film formed on the substrate under the condition (C) based on the first or second method. In the case of using the fourth method, the coated article comprises the brilliant coating film formed on the substrate under the condition (D) based on any one of the first to third methods. In the case of using the fifth method, the coated article comprises the brilliant coating film, which is formed on the substrate by using the aqueous second brilliant base coating composition containing 0.1 to 5 parts by mass of the fluorine- or silicone-based additive per 100 parts by mass of the vehicle solid contents, based on any one of the first to fourth methods.

The present invention will be described in more detail below with reference to Examples and Comparative Examples without intention of limiting the scope of the present invention. Unless otherwise noted, the amounts of components are shown as the mass ratio (parts by mass), and the trade names of raw materials, coating compositions, and apparatuses are used.

### EXAMPLES 1 TO 16 AND COMPARATIVE EXAMPLES 1 TO 5

Preparation of Substrates 1 and 2

A dull steel plate having a length of 300 mm, a width of 100 mm, and a thickness of 0.8 mm was treated with zinc phosphate. Then, a cationic electrodeposition coating composition (POWERTOP V-50, Nippon Paint Co., Ltd.) was electrodeposited onto the dull steel plate and baked at 160° C. for 30 minutes to obtain an electrodeposition coating film having a dry film thickness of 25 μm. An intermediate coating composition (ORGA P-5 Sealer, Nippon Paint Co., Ltd.) was applied onto the electrodeposition coating film by an air spray coating process and baked at 140° C. for 30 minutes to form an intermediate coating film having a dry film thickness of 40 μm, whereby a substrate 1 was prepared.

A plastic polypropylene plate having a length of 300 mm, a width of 100 mm, and a thickness of 3.0 mm was washed and degreased. Then, the degreased plate was spray-coated with a primer (RB116 Primer, Nippon Bee Chemical Co., Ltd.) and dried at a surface temperature of 80° C. for 10 minutes such that the film of the primer had a dry film thickness of 10 μm, whereby a substrate 2 was prepared.

Step (1): Formation of First Base Coating

An aqueous first base coating composition containing a brilliant pigment in an amount as shown in Table 1, which is divided into three parts (1), (2), and (3), and a necessary color pigment to be mixed was applied to the substrate 1 or 2 so as to form the first base coating with a dry film thickness as shown in Table 1 such that the substrate 1 or 2 was coated with the first base coating film at the first stage of a base coating zone. Here, the aqueous first base coating composition was prepared by using an acryl-melamine resin coating composition (AQUAREX AR2100, Nippon Paint Co., Ltd.) as a base material so that the properties of the base coating were controlled as shown in Table 1. In Example 11, on the other hand, an aqueous melamine-carbodiimide-acryl coating composition (KX-0077, Nippon Bee Chemical Co., Ltd.) was used as a base material.

Step (2): Formation of Second Base Coating

After the aqueous first base coating was subjected to setting for 2 minutes, and an aqueous second base coating composition containing a brilliant pigment in an amount as shown in Table 1, a color pigment to be mixed as necessary, and an additive agent was applied thereon in a wet-on-wet condition at the second stage of the base coating zone such that the second base coating was formed with a dry film thickness as shown in Table 1. Here, the aqueous second base coating composition containing a brilliant pigment was prepared with an acryl-melamine resin coating composition (AQUAREX AR2100, Nippon Paint Co., Ltd.) as a base material such that the properties of the base coating were controlled as shown in Table 1. In Example 11, on the other hand, an aqueous melamine-carbodiimide-acryl coating composition (KX-0077, Nippon Bee Chemical Co., Ltd.) was used as a base material.

Step (3): Formation of Clear Coating (First Brilliant Coating Film Formation Method)

The second base coating was subjected to setting for 2 minutes, preheated at 80° C. for 3 minutes, and coated with the following clear coating composition in a clear coating zone such that the formed clear coating had a dry film thickness of 35 gm. A acrylic resin-based solution-type clear coating composition (SUPERLAC 0-100 Clear, Nippon Paint Co., Ltd.) was used as a clear coating composition 1, and a solution-type clear coating composition composed of a blend of a carboxyl-containing polymer and an epoxy-containing polymer (MACFLOW 0-330 Clear, Nippon Paint Co., Ltd.) was used as a clear coating composition 2. The substrate 2 was spray-coated with an acryl-urethane clear coating composition 3 (R290 Clear, Nippon Bee Chemical Co., Ltd.) such that the clear coating had a dry film thickness of 30 μm.

Step (4): Heat-Curing of Uncured Coatings (First Brilliant Coating Film Formation Method)

The clear coating was subjected to setting at the room temperature for 10 minutes, and baked at 140° C. for 30 minutes. In the case of the substrate 2, the clear coating was subjected to setting at the room temperature for 10 minutes, and baked 80° C. for 20 minutes. The brilliantness of thus-obtained multilayered coating film was evaluated by the following evaluation method. The results are shown in Table 1.

Step (5): Heat-Curing of Uncured Coatings (Second Brilliant Coating Film Formation Method): Example 12

The formed base coatings were baked at 140° C. for 30 minutes. The brilliantness of thus-obtained multilayered coating film was evaluated by the following evaluation method. The results are shown in Table 1.

Evaluation Method

Finished appearance: A sample coating film was observed from approximately the front (a highlight portion) and from an approximately 15-degree angle (a shade portion) to evaluate visually the sparkling effect that shows the quality of the metallic coating film appearance and the appearance of the coating. The coating film which was observed less sparkling effect was evaluated as much better.
⊚ (Excellent): No sparkling effect. No uneven brilliantness or lowered orientation property were observed. The film had an excellent metallic finished appearance.
◯ (Good): No sparkling effect. The film had a metallic finished appearance.
Δ (Fair): Sparkling effect on the shade portion.
x (Poor): Sparkling effect on both highlight and shade portions. The film had an ordinal metallic appearance. Uneven brilliantness or lowered orientation was observed.

FF effect (flip-flop effect): Difference in brightness observed from between approximately the front (highlight portion) and the approximately 15-degree angle (shade portion) was evaluated. The flip-flop property may refer to difference in the reflection intensity as the observation angle (or the light-receiving angle) is changed.
502 (Excellent): Extremely large brightness difference between different angles.
◯ (Good): Large brightness difference between different angles.
Δ (Fair): Small brightness difference between different angles.
   x (Poor): Almost no brightness difference between different angles. An ordinal metallic appearance.

The following brilliant pigments, color pigments, and additives shown in Table 1 were used.

Brilliant Pigments

1: Aluminum flake pigment; Aluminum Paste MH-8801 (ASAHI KASEI CORPORATION).
2: Aluminum flake pigment; Aluminum Paste 91-0562 (TOYO ALUMINIUM K.K.).
3: Interference mica pigment; Xirallic T60-23WIII (Merck Ltd., Japan).
   Color Pigments
1: Carbon black pigment; MA-100 (MITSUBISHI CHEMICAL CORPORATION).
2: Phthalocyanine blue pigment; Cyanine Blue G314 (SANYO COLOR WORKS, Ltd.).
   Additives
1: Fluorinated alkyl carboxylate; Florade FC-129 (SUMITOMO 3M LIMITED).
2: Organic modified polysiloxane; BYK-341 (BYK-Chemie JAPAN).

In Table 1 and following Tables 2 and 3 in the specification, each example or comparative example is described in Substrate, Brilliant pigment (Type and Amount(PWC)), Solvent, Solid content of coating composition, Dry film thickness, Organic solvent/water ratio, Solid content ratio between first and second coating compositions, Brilliant pigment PWC ratio between first and second coating compositions, Dry film thickness ratio between first and second coating films, Clear top coating composition, and Evaluations in Finished appearance and FF effect.

TABLE 1 (1)

| | | | First base coating | | | | |
|---|---|---|---|---|---|---|---|
| | | | Brilliant pigment | | | | |
| | | | | (A-2) | Solvent | (A-1) | Dry film |
| | | | | Amount | No | Solid content of coating | thickness |
| | | Substrate | Type | (PWC) | (Table 4) | composition (%) | (μm) |
| Example | 1 | 1 | 1 | 15 | 1 | 20 | 6 |
| | 2 | 1 | 1 | 10 | 1 | 20 | 8 |
| | 3 | 1 | 2 | 10 | 1 | 20 | 8 |
| | 4 | 1 | 2 | 10 | 1 | 20 | 8 |
| | 5 | 1 | 3 | 10 | 1 | 20 | 8 |
| | 6 | 1 | 1 | 5 | 1 | 20 | 8 |
| | 7 | 1 | 1 | 10 | 1 | 30 | 8 |
| | 8 | 1 | 1 | 10 | 1 | 20 | 12 |
| | 9 | 1 | 2 | 10 | 1 | 20 | 8 |
| | 10 | 1 | 1 | 10 | 1 | 20 | 8 |
| | 11 | 2 | 1 | 10 | 1 | 20 | 8 |
| | 12 | 1 | 1 | 10 | 1 | 20 | 8 |
| | 13 | 1 | 1 | 10 | 1 | 20 | 8 |
| | 14 | 1 | 1 | 10 | 1 | 20 | 8 |
| | 15 | 1 | 1 | 10 | 1 | 11 | 8 |
| | 16 | 1 | 1 | 10 | 1 | 40 | 8 |
| Comparative | 1 | 1 | 1 | 15 | 7 | 20 | 6 |
| Example | 2 | 1 | 1 | 15 | 7 | 5 | 6 |
| | 3 | 1 | 1 | 15 | 7 | 50 | 6 |
| | 4 | 1 | 1 | 15 | 7 | 25 | 6 |
| | 5 | 1 | 1 | 15 | 7 | 20 | 6 |

TABLE 1 (2)

| | | Second base coating | | | | | | | |
|---|---|---|---|---|---|---|---|---|---|
| | | Brilliant pigment | | Other | | | | | |
| | | | (A-2) | pigment | | Surfactant | | (A-1) Solid content of | Dry film |
| | | | Amount | | Amount | | Amount | coating composition | thickness |
| | | Type | (PWC) | Type | (PWC) | Type | (PHR) | (%) | (μm) |
| Example | 1 | 1 | 15 | — | — | — | — | 15 | 6 |
| | 2 | 1 | 20 | — | — | — | — | 15 | 4 |
| | 3 | 1 | 20 | — | — | — | — | 15 | 4 |
| | 4 | 2 | 20 | — | — | — | — | 15 | 4 |
| | 5 | 3 | 20 | 2 | 5 | — | — | 15 | 4 |
| | 6 | 1 | 15 | — | — | — | — | 15 | 4 |
| | 7 | 1 | 20 | — | — | — | — | 15 | 4 |
| | 8 | 1 | 20 | — | — | — | — | 15 | 3 |
| | 9 | 2 | 20 | 1 | 2 | — | — | 15 | 4 |
| | 10 | 1 | 20 | — | — | — | — | 15 | 4 |
| | 11 | 1 | 20 | — | — | — | — | 15 | 4 |
| | 12 | 1 | 20 | — | — | — | — | 15 | 4 |
| | 13 | 1 | 20 | — | — | 1 | 0.5 | 15 | 4 |
| | 14 | 1 | 20 | — | — | 2 | 0.5 | 15 | 4 |
| | 15 | 1 | 20 | — | — | — | — | 10 | 4 |
| | 16 | 1 | 20 | — | — | — | — | 10 | 4 |
| Comparative | 1 | 1 | 15 | — | — | — | — | 20 | 6 |
| Example | 2 | 1 | 15 | — | — | — | — | 20 | 6 |
| | 3 | 1 | 15 | — | — | — | — | 20 | 6 |
| | 4 | 1 | 15 | — | — | — | — | 5 | 6 |
| | 5 | 1 | 15 | — | — | — | — | 45 | 6 |

TABLE 1 (3)

| | | | (B-1) | (B-2) | (D) Dry film | | | |
|---|---|---|---|---|---|---|---|---|
| | | (A-3) Organic | Solid content ratio | Brilliant pigment PWC | thickness ratio | | | |
| | | solvent/water ratio of | between first and | ratio between first and | between first | Clear top coating | Evaluation results | |
| | | first base coating | second base coating | second base coating | and second | Coating | Finished | |
| | | composition | compositions | compositions | base coatings | composition | appearance | FF effect |
| Example | 1 | 30/70 | 1.3/1 | 1/1 | 1/1 | 1 | ◯ | ◯ |
| | 2 | 30/70 | 1.3/1 | 1/2 | 2/1 | 1 | ⊚ | ◯ |
| | 3 | 30/70 | 1.3/1 | 1/2 | 2/1 | 1 | ⊚ | ◯ |
| | 4 | 30/70 | 1.3/1 | 1/2 | 2/1 | 1 | ◯ | ⊚ |
| | 5 | 30/70 | 1.3/1 | 1/2 | 2/1 | 1 | ◯ | ◯ |
| | 6 | 30/70 | 1.3/1 | 1/3 | 2/1 | 1 | ⊚ | ◯ |
| | 7 | 30/70 | 2/1 | 1/2 | 2/1 | 1 | ⊚ | ⊚ |
| | 8 | 30/70 | 1.3/1 | 1/2 | 4/1 | 1 | ◯ | ⊚ |
| | 9 | 30/70 | 1.3/1 | 1/2 | 2/1 | 1 | ⊚ | ⊚ |
| | 10 | 30/70 | 1.3/1 | 1/2 | 2/1 | 2 | ⊚ | ◯ |
| | 11 | 30/70 | 1.3/1 | 1/2 | 2/1 | 3 | ⊚ | ◯ |
| | 12 | 30/70 | 1.3/1 | 1/2 | 2/1 | — | ⊚ | ◯ |
| | 13 | 30/70 | 1.3/1 | 1/2 | 2/1 | 1 | ⊚ | ⊚ |
| | 14 | 30/70 | 1.3/1 | 1/2 | 2/1 | 1 | ⊚ | ⊚ |
| | 15 | 30/70 | 1.1/1 | 1/2 | 2/1 | 1 | ◯ | ⊚ |
| | 16 | 30/70 | 4/1 | 1/2 | 2/1 | 1 | ⊚ | ◯ |
| Comparative | 1 | 30/70 | 1/1 | 1/1 | 1/1 | 1 | X | Δ |
| Example | 2 | 30/70 | 0.3/1 | 1/1 | 1/1 | 1 | X | X |
| | 3 | 30/70 | 2.5/1 | 1/1 | 1/1 | 1 | X | X |
| | 4 | 30/70 | 5/1 | 1/1 | 1/1 | 1 | X | Δ |
| | 5 | 30/70 | 0.4/1 | 1/1 | 1/1 | 1 | X | X |

### EXAMPLES 17 TO 30 AND COMPARATIVE EXAMPLES 6 TO 10

Preparation of Substrates 1 and 3

The substrates 1 and 2 were prepared in the same manner as Examples 1 to 16.

Step (1): Formation of First Base Coating

The substrate 1 or 2 was coated with an aqueous first base coating composition at the first stage of a base coating zone such that the first base coating had a dry film thickness as shown in Table 2, which is divided into three parts (1), (2), and (3). The aqueous first base coating composition contained an amount of a brilliant pigment shown in Table 2 and a necessary color pigment as required. Here, the aqueous first base coating composition was prepared with an acryl-melamine resin coating composition (AQUAREX AR2100, Nippon Paint Co., Ltd.) as a base material so that the properties of the base coating were controlled as shown in Table 2. In Example 27, on the other hand, an aqueous melamine-carbodiimide-acryl coating composition (KX-0077, Nippon Bee Chemical Co., Ltd.) was used as a base material.

Step (2): Formation of Second Base Coating

After the first base coating was subjected to setting for 2 minutes, an aqueous second base coating composition containing the following kind of brilliant pigment as much as shown in Table 2, a necessary color pigment and a necessary additive was applied in a wet-on-wet condition at the second stage of the base coating zone such that the second base coating had a dry film thickness as shown in Table 2. Here, the aqueous second base coating composition was prepared with an acryl-melamine resin coating composition (AQUAREX AR2100, Nippon Paint Co., Ltd.) as a base material, such that the properties of the base coating were controlled as shown in Table 2. In Example 27, on the other hand, an aqueous melamine-carbodiimide-acryl coating composition (KX-0077, Nippon Bee Chemical Co., Ltd.) was used as a base material.

Step (3): Formation of Clear Coating (First Brilliant Coating Film Formation Method)

The second base coating was subjected to setting for 2 minutes, preheated at 80° C. for 3 minutes, and coated with the following clear coating composition in a clear coating zone such that the formed clear coating had a dry film thickness of 35 pm. A clear coating composition 1: acrylic resin-based solution-type clear composition (SUPERLAC 0-100 Clear, Nippon Paint Co., Ltd.) and a clear coating composition 2: a clear solution-type coating composition composed of a blend of a carboxyl-containing polymer and an epoxy-containing polymer (MACFLOW 0-330 Clear, Nippon Paint Co., Ltd.) were used. The substrate 2 was spray-coated with an acryl-urethane coating composition (R290 Clear, Nippon Bee Chemical Co., Ltd.) such that the clear coating had a dry film thickness of 30 μm.

Step (4): Heat-Curing of Uncured Coatings (First Brilliant Coating Film Formation Method)

The clear coating was subjected to setting at the room temperature for 10 minutes, and baked at 140° C. for 30 minutes. In the case of using the substrate 3, the clear coating was subjected to setting at the room temperature for 10 minutes, and baked 80° C. for 20 minutes. The brilliantness of thus-obtained multilayered coating film was evaluated in the same manner as employed with Examples 1 to 16. The results are shown in Table 2. The brilliant pigments, the color pigments, and the additives shown in Table 2 are identical to those used in Examples 1 to 16.

Step (5): Heat-Curing of Uncured Coatings (Second Brilliant Coating Film Formation Method): Example 28

The formed second base coating was subjected to setting at the room temperature for 10 minutes, and baked at 140° C. for 30 minutes. The brilliantness of thus-obtained multilayered coating film was evaluated in the same manner as employed with Examples 1 to 16. The results are shown in Table 2.

TABLE 2 (1)

| | | | First base coating | | | | |
|---|---|---|---|---|---|---|---|
| | | | Brilliant pigment | | | (A-1) | |
| | | | | (A-2) | Solvent | Solid content of | Dry film |
| | | | | Amount | No. | coating composition | thickness |
| | | Substrate | Type | (PWC) | (Table 4) | (%) | (μm) |
| Example | 17 | 1 | 1 | 6 | 1 | 23 | 6 |
| | 18 | 1 | 1 | 6 | 1 | 23 | 8 |
| | 19 | 1 | 2 | 6 | 1 | 23 | 8 |
| | 20 | 1 | 2 | 6 | 1 | 23 | 8 |
| | 21 | 1 | 1 | 6 | 1 | 23 | 8 |
| | 22 | 1 | 1 | 6 | 1 | 23 | 10 |
| | 23 | 1 | 1 | 2 | 1 | 23 | 8 |
| | 24 | 1 | 1 | 30 | 1 | 23 | 8 |
| | 25 | 1 | 1 | 6 | 1 | 23 | 8 |
| | 26 | 1 | 1 | 6 | 1 | 23 | 8 |
| | 27 | 2 | 1 | 6 | 1 | 23 | 8 |
| | 28 | 1 | 1 | 6 | 1 | 23 | 8 |
| | 29 | 1 | 1 | 6 | 1 | 23 | 8 |
| | 30 | 1 | 1 | 6 | 1 | 23 | 8 |
| Comparative | 6 | 1 | 1 | 15 | 7 | 23 | 6 |
| | 7 | 1 | 1 | 15 | 7 | 23 | 8 |
| | 8 | 1 | 1 | 0.5 | 7 | 23 | 8 |
| | 9 | 1 | 1 | 35 | 7 | 23 | 8 |
| | 10 | 1 | 1 | 15 | 7 | 23 | 8 |

TABLE 2 (2)

| | | Second base coating | | | | | | | |
|---|---|---|---|---|---|---|---|---|---|
| | | Brilliant pigment | | Other | | | | (A-1) | |
| | | | (A-2) | pigment | | Surfactant | | Solid content of | Dry film |
| | | | Amount | | Amount | | Amount | coating composition | thickness |
| | | Type | (PWC) | Type | (PWC) | Type | (PHR) | (%) | (μm) |
| Example | 17 | 1 | 18 | — | — | — | — | 16 | 6 |
| | 18 | 1 | 18 | — | — | — | — | 16 | 4 |
| | 19 | 1 | 18 | — | — | — | — | 16 | 4 |
| | 20 | 2 | 18 | — | — | — | — | 16 | 4 |
| | 21 | 1 | 18 | 2 | 5 | — | — | 16 | 4 |
| | 22 | 1 | 18 | — | — | — | — | 16 | 2 |
| | 23 | 1 | 8 | — | — | — | — | 16 | 4 |
| | 24 | 1 | 33 | — | — | — | — | 16 | 4 |
| | 25 | 1 | 18 | 1 | 2 | — | — | 16 | 4 |
| | 26 | 1 | 18 | — | — | — | — | 16 | 4 |
| | 27 | 1 | 18 | — | — | — | — | 16 | 4 |
| | 28 | 1 | 18 | — | — | — | — | 16 | 4 |
| | 29 | 1 | 18 | — | — | 1 | 0.5 | 16 | 4 |
| | 30 | 1 | 18 | — | — | 2 | 0.5 | 16 | 4 |
| Comparative | 6 | 1 | 15 | — | — | — | — | 23 | 6 |
| Example | 7 | 1 | 15 | — | — | — | — | 23 | 4 |
| | 8 | 1 | 2.5 | — | — | — | — | 23 | 4 |
| | 9 | 1 | 39 | — | — | — | — | 23 | 4 |
| | 10 | 1 | 45 | — | — | — | — | 23 | 4 |

TABLE 2 (3)

| | | | (B-1) Solid | (B-2) Brilliant | | | | |
|---|---|---|---|---|---|---|---|---|
| | | (A-3) Organic | content ratio | pigment PWC | (D) Dry film | | | |
| | | solvent/water | between first | ratio between | thickness ratio | | | |
| | | ratio of first base | and second | first and second | between first | Clear top coating | | |
| | | coating | base coating | base coating | and second | Coating | Evaluation results | |
| | | composition | compositions | compositions | base coatings | composition | Finished appearance | FF effect |
| Example | 17 | 30/70 | 1.4/1 | 1/3 | 1/1 | 1 | ◯ | ◯ |
| | 18 | 30/70 | 1.4/1 | 1/3 | 2/1 | 1 | ⊚ | ◯ |
| | 19 | 30/70 | 1.4/1 | 1/3 | 2/1 | 1 | ◯ | ◯ |
| | 20 | 30/70 | 1.4/1 | 1/3 | 2/1 | 1 | ◯ | ⊚ |
| | 21 | 30/70 | 1.4/1 | 1/3 | 2/1 | 1 | ⊚ | ◯ |
| | 22 | 30/70 | 1.4/1 | 1/3 | 5/1 | 1 | ⊚ | ◯ |
| | 23 | 30/70 | 1.4/1 | 1/4 | 2/1 | 1 | ◯ | ⊚ |
| | 24 | 30/70 | 1.4/1 | 1/1.1 | 2/1 | 1 | ⊚ | ⊚ |
| | 25 | 30/70 | 1.4/1 | 1/3 | 2/1 | 1 | ⊚ | ⊚ |
| | 26 | 30/70 | 1.4/1 | 1/3 | 2/1 | 2 | ⊚ | ◯ |
| | 27 | 30/70 | 1.4/1 | 1/3 | 2/1 | 3 | ⊚ | ◯ |
| | 28 | 30/70 | 1.4/1 | 1/3 | 2/1 | — | ⊚ | ◯ |
| | 29 | 30/70 | 1.4/1 | 1/3 | 2/1 | 1 | ⊚ | ⊚ |
| | 30 | 30/70 | 1.4/1 | 1/3 | 2/1 | 1 | ⊚ | ⊚ |
| Comparative | 6 | 30/70 | 1/1 | 1/1 | 1/1 | 1 | X | Δ |
| Example | 7 | 30/70 | 1/1 | 1/1 | 2/1 | 1 | Δ | Δ |
| | 8 | 30/70 | 1/1 | 1/5 | 2/1 | 1 | Δ | X |
| | 9 | 30/70 | 1/1 | 1/1.1 | 2/1 | 1 | X | Δ |
| | 10 | 30/70 | 1/1 | 1/3 | 2/1 | 1 | X | Δ |

### EXAMPLES 31 TO 46 AND COMPARATIVE EXAMPLES 11 TO 14

Preparation of Substrates 1 and 2

The substrates 1 and 2 were prepared in the same manner as used in Examples 1 to 30.

Step (1): Formation of First Base Coating

The substrate 1 or 2 was coated with an aqueous first base coating composition at the first stage of a base coating zone such that the first base coating had a dry film thickness as shown in Table 3, which is divided into three parts (1), (2), and (3). The aqueous first base coating composition contained an amount of a brilliant pigment shown in Table 3 and a solvent as shown in Tables 3 and 4, and further contained a color pigment if necessary. The aqueous first base coating composition was prepared by using an acryl-melamine resin coating composition (AQUAREX AR2100, Nippon Paint Co., Ltd.) as a base material such that the properties of the base coating were controlled as shown in Table 3. In Example 43, on the other hand, an aqueous melamine-carbodiimide-acryl coating composition (KX-0077, Nippon Bee Chemical Co., Ltd.) was used as a base material.

Here, each solvent number in Table 4 is assigned by a composition thereof, which may comprise deionized water, methyl alcohol, isopropyl alcohol, acetone, 2-butoxy-ethan, xylen, toluene, or a combination thereof. Each organic component may be evaluated by the evaporation rate and solubility parameter as shown in Table 4. Each solvent is evaluated in the mass ratio of the particular organic solvent.

Step (2): Formation of Second Base Coating

After the first base coating was subjected to setting for 2 minutes, an aqueous second base coating composition at the second stage of the base coating zone was applied in a wet-on-wet condition such that the second base coating had a dry film thickness as shown in Table 3. Here, the aqueous second base coating composition contained an amount of a brilliant pigment as shown in Table 3 and a solvent as shown in Tables 3 and 4 and a necessary color pigment and a necessary additive as required.

The aqueous second base coating composition was prepared with an acryl-melamine resin coating composition (AQUAREX AR2100, Nippon Paint Co., Ltd.) as a base material and the properties of the base coating were controlled as shown in Table 3. In Example 43, on the other hand, an aqueous melamine-carbodiimide-acryl coating composition (KX-0077, Nippon Bee Chemical Co., Ltd.) was used as a base material.

Step (3): Formation of Clear Coating (First Brilliant Coating Film Formation Method)

The second base coating was subjected to setting for 3 minutes, preheated at 80° C. for 3 minutes, and coated with the following clear coating composition in a clear coating zone such that the formed clear coating had a dry film thickness of 35 μm. A clear coating composition 1: an acrylic resin-based solution-type clear coating composition (SUPERLAC 0-100 Clear, Nippon Paint Co., Ltd.) and a clear coating composition 2: a solution-type clear coating composition composed of a blend of a carboxyl-containing polymer and an epoxy-containing polymer (MACFLOW 0-330 Clear, Nippon Paint Co., Ltd.) were used. The substrate 2 was spray-coated with an acryl-urethane clear coating composition (R290 Clear, Nippon Bee Chemical Co., Ltd.) such that the clear coating had a dry film thickness of 30 μm.

Step (4): Heat-Curing of Uncured Coatings (First Brilliant Coating Film Formation Method)

The clear coating was subjected to setting at the room temperature for 10 minutes, and baked at 140° C. for 30 minutes. In the case of the substrate 2, the formed clear coating was subjected to setting at the room temperature for 10 minutes, and baked 80° C. for 20 minutes. The brilliantness of thus-obtained multilayered coating film was evaluated in the same manner as employed in Examples 1 to 30. The results are shown in Table 3. The brilliant pigments, the color pigments, and the additives shown in Table 3 are identical to those used in Examples 1 to 30.

Step (5): Heat-Curing of Uncured Coatings (Second Brilliant Coating Film Formation Method): Example 44

The formed second base coating was subjected to setting at the room temperature for 10 minutes, and baked at 140° C. for 30 minutes. The brilliantness of thus-obtained multilayered coating film was evaluated in the same manner as employed in Examples 1 to 30. The results are shown in Table 3.

TABLE (1)

| | | | First base coating | | | | |
|---|---|---|---|---|---|---|---|
| | | | Brilliant pigment | | | (A-1) | |
| | | | | (A-2) | Solvent | Solid content of | Dry film |
| | | | | Amount | No. | coating composition | thickness |
| | | Substrate | Type | (PWC) | (Table 4) | (%) | (μm) |
| Example | 31 | 1 | 1 | 15 | 1 | 24 | 6 |
| | 32 | 1 | 1 | 7 | 1 | 24 | 9 |
| | 33 | 1 | 2 | 7 | 1 | 24 | 9 |
| | 34 | 1 | 2 | 7 | 1 | 24 | 9 |
| | 35 | 1 | 3 | 7 | 1 | 24 | 9 |
| | 36 | 1 | 1 | 7 | 2 | 24 | 9 |
| | 37 | 1 | 1 | 7 | 3 | 24 | 9 |
| | 38 | 1 | 1 | 7 | 4 | 24 | 9 |
| | 39 | 1 | 1 | 7 | 1 | 30 | 9 |
| | 40 | 1 | 1 | 10 | 1 | 24 | 9 |
| | 41 | 1 | 1 | 7 | 1 | 24 | 9 |
| | 42 | 1 | 1 | 7 | 1 | 24 | 9 |
| | 43 | 2 | 1 | 7 | 1 | 24 | 9 |
| | 44 | 1 | 1 | 7 | 1 | 24 | 9 |
| | 45 | 1 | 1 | 7 | 1 | 24 | 9 |
| | 46 | 1 | 1 | 7 | 1 | 24 | 9 |
| Comparative | 11 | 1 | 1 | 15 | 5 | 24 | 6 |
| Example | 12 | 1 | 1 | 15 | 6 | 24 | 9 |
| | 13 | 1 | 1 | 15 | 7 | 24 | 9 |
| | 14 | 1 | 1 | 15 | 8 | 24 | 9 |

TABLE 3 (2)

| | | Second base coating | | | | | | | | |
|---|---|---|---|---|---|---|---|---|---|---|
| | | Brilliant pigment | | Color | | | | | (A-1) | |
| | | | (A-2) | pigment | | Additive | | Solvent | Solid content of | Dry film |
| | | | Amount | | Amount | | Amount | No. | coating composition | thickness |
| | | Type | (PWC) | Type | (PWC) | Type | (PHR) | (Table 2) | (%) | (μm) |
| Example | 31 | 1 | 15 | — | — | — | — | 5 | 24 | 6 |
| | 32 | 1 | 18 | — | — | — | — | 5 | 15 | 3 |
| | 33 | 1 | 18 | — | — | — | — | 5 | 15 | 3 |
| | 34 | 2 | 18 | — | — | — | — | 5 | 15 | 3 |
| | 35 | 3 | 18 | 2 | 5 | — | — | 5 | 15 | 3 |
| | 36 | 1 | 18 | — | — | — | — | 5 | 15 | 3 |
| | 37 | 1 | 18 | — | — | — | — | 5 | 15 | 3 |
| | 38 | 1 | 18 | — | — | — | — | 5 | 15 | 3 |
| | 39 | 1 | 18 | — | — | — | — | 5 | 15 | 3 |
| | 40 | 1 | 15 | — | — | — | — | 5 | 15 | 3 |
| | 41 | 1 | 18 | 1 | 2 | — | — | 5 | 15 | 3 |
| | 42 | 1 | 18 | — | — | — | — | 5 | 15 | 3 |
| | 43 | 1 | 18 | — | — | — | — | 5 | 15 | 3 |
| | 44 | 1 | 18 | — | — | — | — | 5 | 15 | 3 |
| | 45 | 1 | 18 | — | — | 1 | 0.5 | 5 | 15 | 3 |
| | 46 | 1 | 18 | — | — | — | — | 5 | 15 | 3 |
| Comparative | 11 | 1 | 15 | — | — | — | — | 5 | 24 | 6 |
| Example | 12 | 1 | 15 | — | — | — | — | 5 | 24 | 3 |
| | 13 | 1 | 15 | — | — | — | — | 5 | 24 | 3 |
| | 14 | 1 | 15 | — | — | — | — | 5 | 24 | 3 |

TABLE 3 (3)

| | | | | (B-2) Brilliant | | | | |
|---|---|---|---|---|---|---|---|---|
| | | | (B-1) Solid | pigment PWC | | | | |
| | | (A-3) Organic | content ratio | ratio between | (D) Dry film | | | |
| | | solvent/water | between first | first and | thickness ratio | Clear top | | |
| | | ratio of first | and second | second base | between first | coating | Evaluation results | |
| | | base coating | base coating | coating | and second | Coating | Finished | |
| | | composition | compositions | compositions | base coatings | composition | appearance | FF effect |
| Example | 31 | 30/70 | 1/1 | 1/1 | 1/1 | 1 | ◯ | ◯ |
| | 32 | 30/70 | 1.6/1 | 1/2.6 | 3/1 | 1 | ⊚ | ◯ |
| | 33 | 30/70 | 1.6/1 | 1/2.6 | 3/1 | 1 | ◯ | ◯ |
| | 34 | 30/70 | 1.6/1 | 1/2.6 | 3/1 | 1 | ◯ | ⊚ |
| | 35 | 30/70 | 1.6/1 | 1/2.6 | 3/1 | 1 | ◯ | ◯ |
| | 36 | 30/70 | 1.6/1 | 1/2.6 | 3/1 | 1 | ⊚ | ⊚ |
| | 37 | 30/70 | 1.6/1 | 1/2.6 | 3/1 | 1 | ◯ | ◯ |
| | 38 | 15/85 | 1.6/1 | 1/2.6 | 3/1 | 1 | ◯ | ◯ |
| | 39 | 30/70 | 2/1 | 1/2.6 | 3/1 | 1 | ⊚ | ◯ |
| | 40 | 30/70 | 1.6/1 | 1/1.5 | 3/1 | 1 | ⊚ | ◯ |
| | 41 | 30/70 | 1.6/1 | 1/2.6 | 3/1 | 1 | ⊚ | ⊚ |
| | 42 | 30/70 | 1.6/1 | 1/2.6 | 3/1 | 2 | ⊚ | ◯ |
| | 43 | 30/70 | 1.6/1 | 1/2.6 | 3/1 | 3 | ⊚ | ⊚ |
| | 44 | 30/70 | 1.6/1 | 1/2.6 | 3/1 | — | ⊚ | ⊚ |
| | 45 | 30/70 | 1.6/1 | 1/2.6 | 3/1 | 1 | ⊚ | ⊚ |
| | 46 | 5/95 | 1.6/1 | 1/2.6 | 3/1 | 1 | ◯ | ⊚ |
| Comparative | 11 | 10/90 | 1/1 | 1/1 | 1/1 | 1 | X | Δ |
| Example | 12 | 2/98 | 1/1 | 1/1 | 3/1 | 1 | X | X |
| | 13 | 30/70 | 1/1 | 1/1 | 3/1 | 1 | X | X |
| | 14 | 30/70 | 1/1 | 1/1 | 3/1 | 1 | X | Δ |

TABLE 4

| | Evaporation rate | | | | | | | | Mass ration (% by mass) of |
|---|---|---|---|---|---|---|---|---|---|
| | — | 370 | 205 | 720 | 10 | 68 | 195 | | of particular organic |
| | Solubility parameter | | | | | | | | solvent having evaporation rate |
| | 23.4 | 14.5 | 11.5 | 9.8 | 10.2 | 8.8 | 8.9 | | of 150 to 800 and solubility |
| | Deionized | Methyl | Isopropyl | | 2-Butoxy- | | | | parameter of 9/5 to 14.5 to organic |
| Solvent No. | water | alcohol | alcohol | Acetone | ethanol | Xylene | Toluene | Total | solvents for base coating composition |
| 1 | 70 | 18 | 0 | 0 | 12 | 0 | 0 | 100 | 60 |
| 2 | 70 | 0 | 24 | 0 | 6 | 0 | 0 | 100 | 80 |
| 3 | 70 | 0 | 0 | 15 | 15 | 0 | 0 | 100 | 50 |
| 4 | 85 | 0 | 9 | 0 | 6 | 0 | 0 | 100 | 60 |
| 5 | 90 | 0 | 2 | 0 | 7 | 1 | 0 | 100 | 20 |
| 6 | 98 | 0 | 0 | 0 | 2 | 0 | 0 | 100 | 0 |
| 7 | 70 | 0 | 3 | 0 | 12 | 15 | 0 | 100 | 10 |
| 8 | 70 | 0 | 3 | 0 | 12 | 0 | 15 | 100 | 10 |

As shown in Tables 1 to 3, the brilliant coating films of the Examples formed by the methods according to the embodiments of the present invention had almost no grain-like surface finish, a metallic appearance without uneven brightness by the aluminum flake pigment, etc. having metallic luster, and an improved flip-flop property by the interference mica pigment, etc. On the other hand, the films of Comparative Examples did not show the advantageous effects.

According to of the present invention, the formed multilayered brilliant coating films may have excellent brightness or brilliantness such that they may be more preferably used in the field where the brilliantness is preferable such as outer shells of the automobile and motorcycle, and parts of the automobile (wheels, bumpers, etc.).

1. A method for forming a brilliant coating film on a substrate, comprising the steps of:
(1) applying an aqueous first brilliant base coating composition to the substrate to form a first base coating at a first stage in a base coating zone;
(2) applying an aqueous second brilliant base coating composition to the first base coating to form a second base coating at a second stage in the base coating zone;
(3) applying a clear coating composition to the second base coating formed in the step (2) to form a clear coating in a clear coating zone; and
(4) simultaneously heating the uncured coatings formed in the steps (1), (2) and (3) to cure the coatings,
with at least one of the following provisos I, II, and III:
the proviso I of a condition (A-1) that the aqueous first brilliant base coating composition has a solid content of 10 to 45% by mass and the aqueous second brilliant base coating composition has a solid content of 10 to 40% by mass, and a condition (B-1) that the ratio of the solid content of the aqueous first brilliant base coating composition to the solid content of the aqueous second brilliant base coating composition is 1.1/1 to 4/1;
the proviso II of a condition (A-2) that the aqueous first brilliant base coating composition has a brilliant pigment mass concentration of 1 to 30% and the aqueous second brilliant base coating composition has a brilliant pigment mass concentration of 5 to 40%, and a condition (B-2) that the ratio of the brilliant pigment mass concentration of the aqueous first brilliant base coating composition to the brilliant pigment mass concentration of the aqueous second brilliant base coating composition is 1/4 to 1/1.1; and
the proviso III of a condition (A-3) that the aqueous first brilliant base coating composition comprises at least one organic solvent and water, and the mass ratio of the at least one organic solvent to the water is from 5/95 to 49/51, and a condition (B-3) that the at least one organic solvent includes 40 to 100% by mass of a particular organic solvent, which has a solubility parameter of 9.5 to 14.5 and an evaporation rate of 150 to 800 when n-butyl acetate has an evaporation rate of 100 at 25° C.

2. A method for forming a brilliant coating film on a substrate, comprising the steps of:
(1) applying an aqueous first brilliant base coating composition to the substrate to form a first base coating at a first stage in a base coating zone;
(2) applying an aqueous second brilliant base coating composition to the first base coating formed in the step (1) to form a second base coating at a second stage in the base coating zone; and
(5) simultaneously heating the uncured coatings formed in the steps (1) and (2) to cure the coatings,
with at least one of the following provisos I, II, and III:
the proviso I of a condition (A-1) that the aqueous first brilliant base coating composition has a solid content of 10 to 45% by mass and the aqueous second brilliant base coating composition has a solid content of 10 to 40% by mass, and a condition (B-1) that the ratio of the solid content of the aqueous first brilliant base coating composition to the solid content of the aqueous second brilliant base coating composition is 1.1/1 to 4/1;
the proviso II of a condition (A-2) that the aqueous first brilliant base coating composition has a brilliant pigment mass concentration of 1 to 30% and the aqueous second brilliant base coating composition has a brilliant pigment mass concentration of 5 to 40%, and a condition (B-2) that the ratio of the brilliant pigment mass concentration of the aqueous first brilliant base coating composition to the brilliant pigment mass concentration of the aqueous second brilliant base coating composition is 1/4 to 1/1.1; and
the proviso III of a condition (A-3) that the aqueous first brilliant base coating composition comprises at least one organic solvent and water, and the mass ratio of the at least one organic solvent to the water is from 5/95 to 49/51, and a condition (B-3) that the at least organic solvent includes 40 to 100% by mass of a particular organic solvent, which has a solubility parameter of 9.5 to 14.5 and an evaporation rate of 150 to 800 when n-butyl acetate has an evaporation rate of 100 at 25° C.

3. The method for forming a brilliant coating film according to claim 1, wherein the method satisfies a condition (C) that the aqueous second brilliant base coating composition comprises at least one organic solvent and water, and the mass ratio of the at least one organic solvent to the water is from 5/95 to 49/51.

4. The method for forming a brilliant coating film according to claim 1, wherein the method satisfies a condition (D) that a ratio of a dry film thickness of the first base coating to a dry film thickness of the second base coating is 1.5/1 to 5/1.

5. The method for forming a brilliant coating film according to claim 1, wherein the aqueous second brilliant base coating composition containes 0.1 to 5 parts by mass of a fluorine- or silicone-based additive per 100 parts by mass of a vehicle solid content.

6. A coated article comprising a brilliant coating film formed by the method according to claim 1.

7. The method for forming a brilliant coating film according to claim 2, wherein the method satisfies a condition (C) that the aqueous second brilliant base coating composition comprises at least one organic solvent and water, and the mass ratio of the at least one organic solvent to the water is from 5/95 to 49/51.

8. The method for forming a brilliant coating film according to claim 2, wherein the method satisfies a condition (D) that a ratio of a dry film thickness of the first base coating to a dry film thickness of the second base coating is 1.5/1 to 5/1.

9. The method for forming a brilliant coating film according to claim 2, wherein the aqueous second brilliant base coating composition containes 0.1 to 5 parts by mass of a fluorine- or silicone-based additive per 100 parts by mass of a vehicle solid content.

10. A coated article comprising a brilliant coating film formed by the method according to claim 2.
